(19) United States
(12) Patent Application Publication
(10) Pub. No.: US 2026/0019224 A1
(43) Pub. Date: Jan. 15, 2026

(54) METHOD AND DEVICE FOR ACTIVATING A RESOURCE AND STORAGE MEDIUM

(71) Applicants: Beijing Xiaomi Mobile Software Co., Ltd., Beijing (CN); Beijing University of Posts and Telecommunications, Beijing (CN)

(72) Inventors: Yajun ZHU, Beijing (CN); Wei HONG, Beijing (CN); Xinyu MA, Beijing (CN); Yong LI, Beijing (CN)

(73) Assignees: Beijing Xiaomi Mobile Software Co., Ltd., Beijing (CN); Beijing University of Posts and Telecommunications, Beijing (CN)

(21) Appl. No.: 18/994,512

(22) PCT Filed: Jul. 15, 2022
(86) PCT No.: PCT/CN2022/106075

§ 371 Date: Jan. 14, 2025

(51) Int. Cl. H04L 5/00; G06F 9/52; H04W 72/11

(52) U.S. Cl. CPC H04L 5/0098; G06F 9/526; H04W 72/11

(57) ABSTRACT

A method for activating a resource, including: a terminal receiving an activate signaling sent by a network device, the activate signaling is configured to indicate to activate a first semi-persistent resource group; deactivating a second semi-persistent resource group; and activating the first semi-persistent resource group, where a mutual exclusion group includes the first semi-persistent resource group and an activated second semi-persistent resource group, and at most one semi-persistent resource group is activated in the mutual exclusion group at a same moment.

### CROSS-REFERENCE

The present application is a U.S. National Stage of International Application No. PCT/CN2022/106075, filed on Jul. 15, 2022, the contents of which are incorporated herein by reference in their entirety for all purposes.

### BACKGROUND OF THE INVENTION

In a mobile communication system, a network device may configure a plurality of semi-persistent resource groups for a terminal, further activate any one of a plurality of configured semi-persistent resource groups for the terminal, and transmit data by using an activated semi-persistent resource group.

### SUMMARY OF THE INVENTION

The present disclosure relates to the field of mobile communication, and in particular, to a method and a device for activating a resource, and a storage medium.

A method and a device for activating a resource and a storage medium are provided according to embodiments of the present disclosure.

According to an aspect of the present disclosure, a method for activating the resource is provided, performed by a terminal, the method including:
receiving an activate signaling sent by a network device, where the activate signaling is configured to indicate to activate a first semi-persistent resource group;
deactivating a second semi-persistent resource group; and
activating the first semi-persistent resource group, where
a mutex group includes the first semi-persistent resource group and an activated second semi-persistent resource group, and at most one semi-persistent resource group is activated in the mutex group at a same moment.

According to an aspect of the present disclosure, a method for activating the resource is provided, performed by a network device, the method including:
sending an activate signaling to a terminal, where the activate signaling is configured to indicate to activate a first semi-persistent resource group,
a mutex group includes the first semi-persistent resource group and an activated second semi-persistent resource group, and at most one semi-persistent resource group is activated in the mutex group at a same moment.

According to an aspect of the present disclosure, a method for activating the resource is provided, performed by a terminal, the method including:
receiving an activate signaling sent by a network device, where the activate signaling is configured to indicate to activate a first semi-persistent resource group; and
activating the first semi-persistent resource group, where
a mutex group includes the first semi-persistent resource group but does not include an activated second semi-persistent resource group, and at most one semi-persistent resource group is activated in the mutex group at a same moment.

According to an aspect of the present disclosure, an electronic device is provided. The electronic device includes a processor, a memory that stores executable instructions, and a transceiver connected to the processor. The executable instructions when executed by the processor cause the electronic device to act as the terminal and perform the method for activating the resource according to the above aspects.

According to an aspect of the present disclosure, a non-transitory computer-readable storage medium is provided. The readable storage medium stores an executable program code. The executable program code, when loaded and executed by a processor of the terminal, cause the terminal to perform the method for activating the resource according to the above aspects.

### BRIEF DESCRIPTION OF DRAWINGS

To describe the technical solutions in embodiments of the present disclosure more clearly, the following briefly describes the accompanying drawings needed to describe the embodiments. It is clear that the accompanying drawings described below are merely some of embodiments of the present disclosure. Without creative efforts, a person of ordinary skill in the art may obtain other drawings based on these accompanying drawings.

FIG. 1 is a block diagram of a communication system according to an example embodiment of the present disclosure;

FIG. 2 is a flowchart of a method for activating the resource according to an example embodiment of the present disclosure;

FIG. 3 is a flowchart of a method for activating the resource according to an example embodiment of the present disclosure;

FIG. 4 is a flowchart of a method for managing a mutex group according to an example embodiment of the present disclosure;

FIG. 5 is a block diagram of a device for activating the resource according to an example embodiment of the present disclosure;

FIG. 6 is a block diagram of another device for activating the resource according to an example embodiment of the present disclosure;

FIG. 7 is a block diagram of another device for activating the resource according to an example embodiment of the present disclosure;

FIG. 8 is a block diagram of another device for activating the resource according to an example embodiment of the present disclosure; and

FIG. 9 is a diagram of a structure of a communication device according to an example embodiment of the present disclosure.

### DETAILED DESCRIPTION OF THE INVENTION

To make objectives, the technical solutions, and merits of the present disclosure clearer, the following further describes implementations of the present disclosure in detail with reference to the accompanying drawings.

Example embodiments are described in detail herein, with their examples illustrated in the accompanying drawings. When the following descriptions relate to the accompanying drawings, identical numbers in different accompanying drawings represent same or similar elements, unless otherwise specified. Implementations described in the following example embodiments do not represent all implementations that are consistent with the present disclosure. Actually, the implementations described in the following example embodiments are merely examples of the devices and methods that are consistent with some aspects of the present disclosure as detailed in the claims attached.

Terms used in the present disclosure are merely intended to describe a particular embodiment, rather than limit the present disclosure. Singular forms “a/an”, “described”, and “the” used in the present disclosure and the claims attached are also intended to include a plural form, unless otherwise clearly expressed in the context. It should also be understood that the term “and/or” used in this specification indicates and includes any or all possible combinations of one or more listed items that are associated.

It should be understood that although terms such as first, second, and third may be used in the present disclosure to describe various information, the information shall not be limited to these terms. These terms are merely used to distinguish between information of a same type. For example, without departing from the scope of the present disclosure, first information may also be referred to as second information, and likewise, second information may also be referred to as first information. Depending on the context, for example, the word “if” used herein may be interpreted as “when . . . ”, “while . . . ”, or “in response to determining”.

It should be noted that information (including but not limited to user device information and user personal information), data (including but not limited to data used for analysis, stored data, and displayed data), and signals used in the present disclosure are all authorized by users or fully authorized by all parties. In addition, related data needs to be collected, used, and processed in compliance with related laws, regulations, and standards in related countries and territories.

In a mobile communication system, a network device may configure a plurality of semi-persistent resource groups for a terminal, further activate any one of a plurality of configured semi-persistent resource groups for the terminal, and transmit data by using an activated semi-persistent resource group.

Specifically, in a case where the terminal already activates a semi-persistent resource group A for data transmission, when the terminal does not need to use the semi-persistent resource group A for data transmission and the network device needs to activate a semi-persistent resource group B for the terminal, the network device sends a deactivate signaling to the terminal to deactivate the semi-persistent resource group A that is already activated by the terminal. Subsequently, the network device sends an activate signaling to the terminal to activate the semi-persistent resource group B indicated in the activate signaling, enabling the terminal to perform data transmission.

However, in a case where the terminal fails to receive the deactivate signaling, it can lead to the coexistence of the semi-persistent resource group A that is previously activated and the semi-persistent resource group B that is activated by using the activate signaling. When time-frequency resources of the two resource groups overlap, data transmission between the terminal and the network device may encounter retransmission, thereby affecting transmission efficiency.

The following describes an application scenario of the present disclosure.

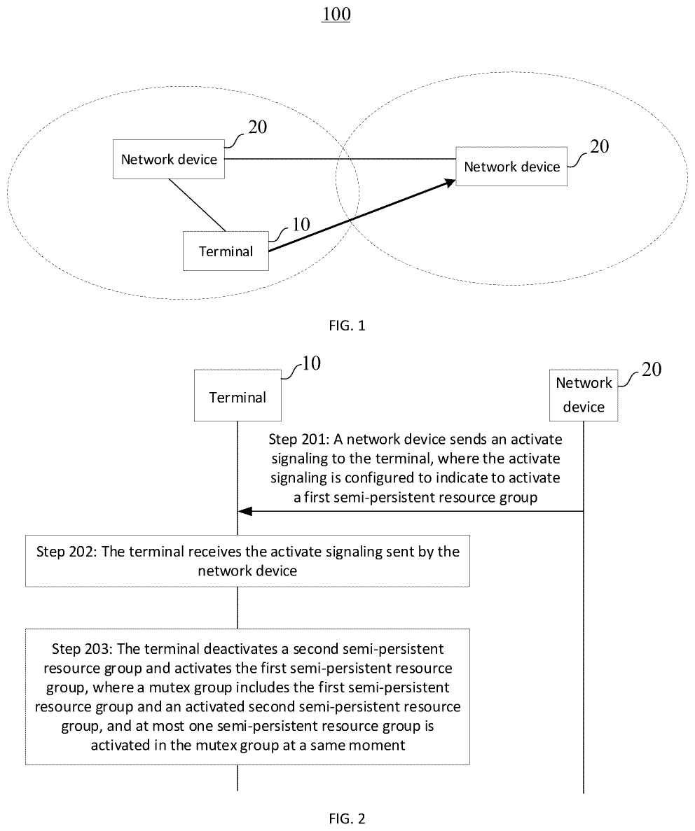

FIG. 1 is a block diagram of a communication system 100 according to an example embodiment of the present disclosure. The communication system 100 may include a terminal 10 and a network device 20.

There are usually a plurality of terminals 10. One or more terminals 10 may be distributed in a cell managed by one network device 20. The terminal 10 may include a variety of handheld devices, vehicle-mounted devices, wearable devices, or computing devices with wireless communication functions, other processing devices connected to a wireless modem, User Equipment (UE) and Mobile Station (MS) in various forms, and the like. For ease of description, the devices mentioned above are collectively referred to as terminals in this embodiment of the present disclosure.

The network device 20 is a device that is deployed in an access network and configured to provide a wireless communication function for terminal 10. For ease of description, the devices provide the wireless communication function for the terminals 10 are collectively referred to as network devices in this embodiment of the present disclosure. A connection may be established between the network device 20 and the terminal 10 by using an air interface. Then, network devices 20 and terminal 10 communicate with each other via the connection, including the exchange of signaling and data. There may be a plurality of network devices 20. Two adjacent network devices may also communicate with each other in a wired or wireless mode. The terminal 10 may be handed over between different network devices 20, that is, establish a connection to different network devices 20.

The network device 20 may include a macro base station, a micro base station, a relay station, an access point, and the like that are in various forms. In a system using a different radio access technology, a device with a network device function may have a different name. For example, the device may be referred to as a gNodeB or a gNB in a 5G new radio (NR) system. As communication technologies evolve, the name “network device” may change.

In some embodiments, the network device 20 configures a semi-persistent scheduling (SPS) resource group or a configured grant (CG) resource group for the terminal 10, so that the terminal 10 performs communication based on a configured SPS resource group or a configured CG resource group.

Alternatively, the SPS resource group or the CG resource group may be applied to an Extended Reality (XR) service. The XR service is a service that provides human-machine communication or human-human communication by a variety of handheld devices or wearable devices.

FIG. 2 is a flowchart of a method for activating a resource according to an example embodiment of the present disclosure. For example, the method may be applied to the terminal and the network device shown in FIG. 1. The method includes at least part of the following content.

Step 201: a network device sends an activate signaling to a terminal, where the activate signaling is configured to indicate to activate a first semi-persistent resource group.

Step 202: the terminal receives the activate signaling sent by the network device.

In this embodiment of the present disclosure, in a case where the network device needs to activate the first semi-persistent resource group, the network device may send the activate signaling to the terminal. After receiving the activate signaling sent by the network device, the terminal can determine that the first semi-persistent resource group needs to be activated based on the activate signaling.

Step 203: the terminal deactivates a second semi-persistent resource group and activates the first semi-persistent resource group, where a mutex (mutual exclusion) group includes the first semi-persistent resource group and an activated second semi-persistent resource group, and at most one semi-persistent resource group is activated in the mutex group at a same moment.

The first semi-persistent resource group and the activated second semi-persistent resource group are included in the mutex group. In addition, at most one semi-persistent resource group is activated within the mutex group at the same moment, which means that a plurality of semi-persistent resource groups within the mutex group cannot all be activated at the same moment. In other words, in a case where the second semi-persistent resource group in the mutex group is activated when the first semi-persistent resource group needs to be activated, the terminal needs to first deactivate the second semi-persistent resource group and then activate the first semi-persistent resource group.

The first semi-persistent resource group includes a plurality of configured time-frequency resources. In some embodiments, the first semi-persistent resource group includes a plurality of time-frequency resources that are arranged periodically. The second semi-persistent resource group includes a plurality of configured time-frequency resources. In some embodiments, the second semi-persistent resource group includes a plurality of time-frequency resources that are arranged periodically.

In some embodiments, a semi-persistent resource group is an SPS resource group or a CG resource group.

For example, in a case where the semi-persistent resource group is the SPS resource group, the semi-persistent resource group may also be referred to as an SPS configuration. In a case where the semi-persistent resource group is the CG resource group, the semi-persistent resource group may also be referred to as a CG configuration.

In some embodiments, time-frequency resources of the plurality of semi-persistent resource groups included in the mutex group overlap. For example, the time-frequency resources of any two semi-persistent resource groups from the plurality of semi-persistent resource groups overlap. For another example, time-frequency resources of at least two semi-persistent resource groups from the plurality of semi-persistent resource groups overlap.

In some other embodiments, time-frequency resources of the plurality of semi-persistent resource groups included in the mutex group do not overlap.

In some embodiments, in a case where the terminal determines that the activated second semi-persistent resource group exists in the mutex group to which the first semi-persistent resource group belongs, the terminal deactivates the second semi-persistent resource group and activates the first semi-persistent resource group.

In other words, the terminal determines the mutex group to which the first semi-persistent resource group belongs. Since at most one semi-persistent resource group is activated within the mutex group at a same moment, in a case where the activated second semi-persistent resource group exists in the mutex group, the terminal needs to first deactivate the second semi-persistent resource group and then activates the first semi-persistent resource group.

It should be noted that in this embodiment of the present disclosure, the steps performed by the terminal may form a new embodiment on their own, and the steps performed by the network device may also form a new embodiment on their own. This is not limited to this embodiment of the present disclosure.

In the solution provided in this embodiment of the present disclosure, the terminal receives the activate signaling that is configured to activate the first semi-persistent resource group. Since at most one semi-persistent resource group is activated within the mutex group at a same moment, and the mutex group includes the first semi-persistent resource group and the activated second semi-persistent resource group, the terminal needs to first deactivate the activated second semi-persistent resource group and then activates the first semi-persistent resource group. In this way, a limitation that a network device needs to use deactivate signaling to indicate to deactivate a second semi-persistent resource group is broken, signaling overheads are reduced, retransmission that occurs due to existence of resource groups that are all activated is prevented, and transmission efficiency is improved.

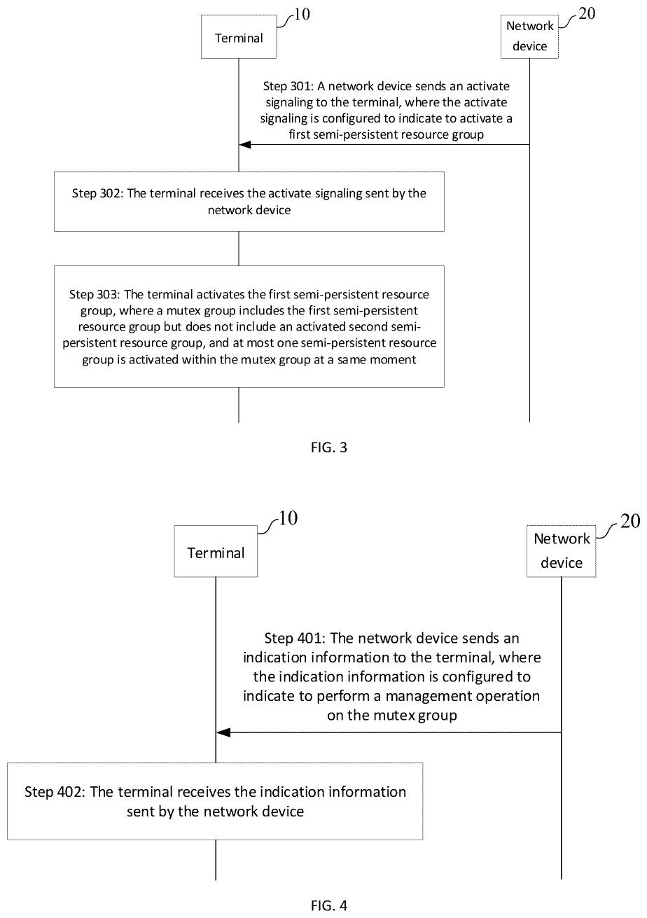

It should be noted that this embodiment of the present disclosure is described by using an example in which the mutex group includes the first semi-persistent resource group and the activated second semi-persistent resource group. However, in another embodiment, there is also a case where the mutex group includes the first semi-persistent resource group but does not include the activated second semi-persistent resource group. In this case, the terminal does not need to perform the deactivate operation. FIG. 3 is a flowchart of a method for activating the resource according to an example embodiment of the present disclosure. For example, the method may be applied to the terminal and the network device shown in FIG. 1. The method includes at least part of the following content.

Step 301: a network device sends an activate signaling to a terminal, where the activate signaling is configured to indicate to activate a first semi-persistent resource group.

Step 302: the terminal receives the activate signaling sent by the network device.

Steps 301 and 302 are similar to steps 201 and 202 in the above embodiment. Details are not described herein again.

Step 303: the terminal activates the first semi-persistent resource group, where a mutex group includes the first semi-persistent resource group but does not include an activated second semi-persistent resource group, and at most one semi-persistent resource group is activated within the mutex group at a same moment.

The mutex group includes the first semi-persistent resource group but does not include an activated second semi-persistent resource group. In addition, at most one semi-persistent resource group is activated within the mutex group at the same moment, which means that at a same moment, a plurality of semi-persistent resource groups within the mutex group cannot all be activated. However, since there is no activated second semi-persistent resource group in the mutex group, in a case where the first semi-persistent resource group needs to be activated, the terminal directly activates the first semi-persistent resource group.

In some embodiments, in a case where the terminal determines that there is no activated second semi-persistent resource group in the mutex group to which the first semi-persistent resource group belongs, the terminal activates the first semi-persistent resource group.

In other words, the terminal determines the mutex group to which the first semi-persistent resource group belongs. In a case where there is no activated second semi-persistent resource group in the mutex group, the terminal directly activates the first semi-persistent resource group.

It should be noted that in this embodiment of the present disclosure, the steps performed by the terminal may form a new embodiment on their own, and the steps performed by the network device may also form a new embodiment on their own. This is not limited to this embodiment of the present disclosure.

In the solution provided in this embodiment of the present disclosure, the terminal receives the activate signaling that is configured to activate the first semi-persistent resource group. Since at most one semi-persistent resource group is activated within the mutex group at a same moment, and the mutex group includes the first semi-persistent resource group but does not include an activated second semi-persistent resource group, the terminal directly activates the first semi-persistent resource group. In this way, accuracy of activating the first semi-persistent resource group by the terminal is ensured, a case where there is still an activated second semi-persistent resource group is prevented from occurring, further, retransmission that occurs due to existence of resource groups that are all activated is prevented, and transmission efficiency is improved.

The embodiments shown in FIG. 2 and FIG. 3 illustrate how to perform a subsequent procedure based on whether the mutex group includes the activated second semi-persistent resource group. The following describes how the network device indicates the terminal to manage a mutex group. FIG. 4 is a flowchart of a method for managing the mutex group according to an example embodiment of the present disclosure. For example, the method may be applied to the terminal and the network device shown in FIG. 1. The method includes at least part of the following content.

Step 401: a network device sends an indication information to a terminal, where the indication information is configured to indicate to perform a management operation on the mutex group.

Step 402: the terminal receives the indication information sent by the network device.

In this embodiment of the present disclosure, the network device manages the mutex group of the terminal so that the terminal adjusts to a semi-persistent resource group included in the mutex group.

In a case where the network device needs to manage the mutex group, the network device sends indication information to the terminal and informs, by using the indication information, of a management operation that needs to be performed by the terminal. After receiving the indication information sent by the network device, the terminal can perform the management operation indicated in the indication information.

In the solution provided in this embodiment of the present disclosure, the terminal determines the indicated management operation based on the received indication information, and manages the mutex group, ensuring accuracy of management of the mutex group.

In some embodiments, the management operation is to configure a mutex group with the first semi-persistent resource group and the second semi-persistent resource group.

In this embodiment of the present disclosure, in a case where the network device needs to configure a mutex group for the terminal, the network device sends indication information to the terminal, a management operation indicated in the indication information is to configure the mutex group by the terminal, with the first semi-persistent resource group and the second semi-persistent resource group. After receiving the indication information, the terminal can determine the mutex group that the network device configures for the terminal.

In some embodiments, the indication information may also be referred to as grouping information, combination information, or other information. This is not limited to this embodiment of the present disclosure. The indication information may be downlink control information (DCI), radio resource control (RRC), or a medium access control control element (MAC CE). This is not limited to this embodiment of the present disclosure.

In this embodiment of the present disclosure, after the terminal receives the indication information, since the indication information indicates the terminal to configure the mutex group with the first semi-persistent resource group and the second semi-persistent resource group, the terminal determines the indicated first semi-persistent resource group and the indicated second semi-persistent resource group based on the indication information, and configures the mutex group with the first semi-persistent resource group and the second semi-persistent resource group.

After the mutex group is configured with the first semi-persistent resource group and the second semi-persistent resource group, there is at most one semi-persistent resource group is activated within the mutex group at a same moment.

In some embodiments, the indication information includes an identifier of the mutex group and an identifier of a semi-persistent resource group, and the semi-persistent resource groups include the first semi-persistent resource group and the second semi-persistent resource group.

The identifier of the mutex group indicates the mutex group. Alternatively, the identifier of the mutex group is an ordinal number of the mutex group. For example, in a case where the identifier of the mutex group is 1, it indicates that an indicated mutex group is a mutex group 1, or in a case where the identifier of the mutex group is 2, it indicates that the indicated mutex group is a mutex group 2.

The identifier of the semi-persistent resource group indicates the semi-persistent resource group. Alternatively, the identifier of the semi-persistent resource group is an ordinal number of the semi-persistent resource group. For example, if the identifier of the semi-persistent resource group is 1, it indicates that an indicated semi-persistent resource group is a semi-persistent resource group 1, or if the identifier of the semi-persistent resource group is 2, it indicates that an indicated semi-persistent resource group is a semi-persistent resource group 2.

In this embodiment of the present disclosure, the terminal determines the identifier of the mutex group and the identifier of the semi-persistent resource group based on the received indication information and configures the mutex group indicated in the identifier of the mutex group based on the semi-persistent resource group indicated in the identifier of the semi-persistent resource group.

For example, in a case where the identifier of the mutex group included in the indication information is 1, and identifiers of the semi-persistent resource group included in the indication information are an identifier 1 of the semi-persistent resource group, an identifier 2 of the semi-persistent resource group, and an identifier 3 of the semi-persistent resource group, the terminal configures a mutex group with the semi-persistent resource group 1, the semi-persistent resource group 2, and the semi-persistent resource group 3, and the identifier of the mutex group is 1.

In some embodiments, the indication information includes a function indication field, and the function indication field indicates the management operation indicated in the indication information. It may be alternatively understood that the function indication field indicates that the management operation indicated in the indication information is configuring the mutex group with the first semi-persistent resource group and the second semi-persistent resource group.

In this embodiment of the present disclosure, the indication information sent by the network device to the terminal includes a function indication field. The function indication field indicates the management operation indicated in the indication information is to configure the mutex group with the first semi-persistent resource group and the second semi-persistent resource group.

For example, the function indication field includes two bits. To be specific, two bits may indicate four different functions. For example, The “00” in the function indication field indicates that the management operation indicated in the indication information is to configure the mutex group with the first semi-persistent resource group and the second semi-persistent resource group; or the “01” in the function indication field indicates that the management operation indicated in the indication information is to configure the mutex group with the first semi-persistent resource group and the second semi-persistent resource group; or the “10” in the function indication field indicates that the management operation indicated in the indication information is to configure the mutex group with the first semi-persistent resource group and the second semi-persistent resource group; or the “11” in the function indication field indicates that the management operation indicated in the indication information is to configure the mutex group with the first semi-persistent resource group and the second semi-persistent resource group.

It should be noted that in this embodiment of the present disclosure, the steps performed by the terminal may form a new embodiment on their own, and the steps performed by the network device may also form a new embodiment on their own. This is not limited to this embodiment of the present disclosure.

In the solution provided in this embodiment of the present disclosure, the terminal configures, based on the indication information sent by the network device, the mutex group with the first semi-persistent resource group and the second semi-persistent resource group, indicating that there is at most one semi-persistent resource group is activated within the mutex group at a same moment. In this way, a limitation that a terminal encounters a case that a plurality of semi-persistent resource groups with mutual exclusivity are all activated is broken, retransmission that occurs due to existence of resource groups that are all activated is prevented, and transmission efficiency is improved.

In some embodiments, the management operation is to add a third semi-persistent resource group to the mutex group. In this embodiment of the present disclosure, the network device configures the mutex group for the terminal, and may further add a semi-persistent resource group to the configured mutex group, so that the terminal determines, based on the configured mutex group, a subsequent procedure of activating the first semi-persistent resource group.

In this embodiment of the present disclosure, in a case where the network device needs to add a semi-persistent resource group to the mutex group, the network device sends indication information to the terminal, a management operation indicated in the indication information is to add the third semi-persistent resource group to the mutex group. After receiving the indication information, the terminal can determine that the network device indicates the terminal to add the third semi-persistent resource group to the mutex group.

In some embodiments, the indication information may also be referred to as addition information, supplementary information or other information. This is not limited to this embodiment of the present disclosure. The indication information may be a DCI, a RRC, or a MAC CE. This is not limited to this embodiment of the present disclosure.

In this embodiment of the present disclosure, the terminal receives the indication information. Then, since the management operation indicated in the indication information is to add the third semi-persistent resource group to the mutex group, the terminal adds the third semi-persistent resource group to the mutex group based on the indication information.

In some embodiments, the indication information includes the identifier of the mutex group and the identifier of the semi-persistent resource group.

The identifier of the mutex group indicates the mutex group. Alternatively, the identifier of the mutex group is an ordinal number of the mutex group. For example, in a case where the identifier of the mutex group is 1, it indicates that an indicated mutex group is a mutex group 1, or in a case where the identifier of the mutex group is 2, it indicates that an indicated mutex group is a mutex group 2.

The identifier of the semi-persistent resource group indicates the semi-persistent resource group. Alternatively, the identifier of the semi-persistent resource group is an ordinal number of the semi-persistent resource group. For example, in a case where the identifier of the semi-persistent resource group is 1, it indicates that an indicated semi-persistent resource group is a semi-persistent resource group 1, or in a case where the identifier of the semi-persistent resource group is 2, it indicates that an indicated semi-persistent resource group is a semi-persistent resource group 2.

In this embodiment of the present disclosure, the terminal determines the identifier of the mutex group and the identifier of the semi-persistent resource group based on the received indication information, and adds a third semi-persistent resource group indicated in the identifier of the semi-persistent resource group to the mutex group indicated in the identifier of the mutex group.

For example, if the identifier of the mutex group included in the indication information is 1, and the identifier of the semi-persistent resource group included in the indication information is 1, the terminal adds a semi-persistent resource group 1 to a mutex group 1.

In some embodiments, the indication information includes a function indication field, and the function indication field indicates the management operation indicated in the indication information. It may be alternatively understood that the function indication field indicates that the management operation indicated in the indication information is to add the third semi-persistent resource group to the mutex group.

In this embodiment of the present disclosure, the indication information sent by the network device to the terminal includes a function indication field. The function indication field indicates that the management operation indicated in the indication information is to add the third semi-persistent resource group to the mutex group.

For example, the function indication field includes two bits. To be specific, two bits may indicate four different functions. For example, the “00” in the function indication field indicates that the management operation indicated in the indication information is to add the third semi-persistent resource group to the mutex group; or the “01” in the function indication field indicates that the management operation indicated in the indication information is to add the third semi-persistent resource group to the mutex group; or the “10” in the function indication field indicates that the management operation indicated in the indication information is to add the third semi-persistent resource group to the mutex group, or the “11” in the function indication field indicates that the management operation indicated in the indication information is to add the third semi-persistent resource group to the mutex group.

It should be noted that in this embodiment of the present disclosure, the steps performed by the terminal may form a new embodiment on their own, and the steps performed by the network device may also form a new embodiment on their own. This is not limited to this embodiment of the present disclosure.

In the solution provided in this embodiment of the present disclosure, the terminal adds the third semi-persistent resource group to the mutex group based on the indication information sent by the network device, ensuring that the mutex group can be adjusted by the network device, and improving flexibility of the mutex group. In addition, the resulting mutex group prevents retransmission, which occurs due to the existence of resource groups that are all activated, improving transmission efficiency.

In some embodiments, the management operation is to remove a fourth semi-persistent resource group from the mutex group. In this embodiment of the present disclosure, the network device configures the mutex group for the terminal, and may further remove a persistent resource group from the configured mutex group, so that the terminal determines, based on the configured mutex group, a subsequent procedure of activating the first semi-persistent resource group.

In this embodiment of the present disclosure, in a case where the network device needs to remove a semi-persistent resource group from the mutex group, the network device sends indication information to the terminal, a management operation indicated in the indication information is to remove a fourth semi-persistent resource group from the mutex group. After receiving the indication information, the terminal can determine that the network device indicates the terminal to remove the fourth semi-persistent resource group from the mutex group.

In some embodiments, the indication information may also be referred to as removal information, deletion information, or other information. This is not limited to this embodiment of the present disclosure. The indication information may be a DCI, a RRC, or a MAC CE. This is not limited to this embodiment of the present disclosure.

In this embodiment of the present disclosure, the terminal receives the indication information. Then, since the management operation indicated in the indication information is to remove the fourth semi-persistent resource group from the mutex group, the terminal removes the fourth semi-persistent resource group from the mutex group based on the indication information.

In some embodiments, the indication information includes the identifier of the mutex group and the identifier of the semi-persistent resource group.

The identifier of the mutex group indicates the mutex group. Alternatively, the identifier of the mutex group is an ordinal number of a mutex group. For example, in a case where the identifier of the mutex group is 1, it indicates that an indicated mutex group is a mutex group 1, or in a case where the identifier of the mutex group is 2, it indicates that an indicated mutex group is a mutex group 2.

The identifier of the semi-persistent resource group indicates the semi-persistent resource group. Alternatively, the identifier of the semi-persistent resource group is an ordinal number of the semi-persistent resource group. For example, in a case where the identifier of the semi-persistent resource group is 1, it indicates that an indicated semi-persistent resource group is a semi-persistent resource group 1, or in a case where the identifier of the semi-persistent resource group is 2, it indicates that an indicated semi-persistent resource group is a semi-persistent resource group 2.

In this embodiment of the present disclosure, the terminal determines the identifier of the mutex group and the identifier of the semi-persistent resource group based on the received indication information, and removes a fourth semi-persistent resource group indicated in the identifier of the semi-persistent resource group from the mutex group indicated in the identifier of the mutex group.

For example, if the identifier of the mutex group included in the indication information is 1, and the identifier of the semi-persistent resource group included in the indication information is 1, the terminal removes a semi-persistent resource group 1 from a mutex group 1.

In some embodiments, the indication information includes a function indication field, and the function indication field indicates the management operation indicated in the indication information. It may be alternatively understood as that the function indication field indicates that the management operation indicated in the indication information is to remove a semi-persistent resource group from a mutex group.

In this embodiment of the present disclosure, the indication information sent by the network device to the terminal includes a function indication field, function indication field indicates that the management operation indicated in the indication information is to remove a semi-persistent resource group from a mutex group.

For example, the function indication field includes two bits. To be specific, two bits may indicate four different functions. For example, the “00” in the function indication field indicates that the management operation indicated in the indication information is to remove the fourth semi-persistent resource group from the mutex group; or the “01” in the function indication field indicates that the management operation indicated in the indication information is to remove the fourth semi-persistent resource group from the mutex group; or the “10” in the function indication field indicates that the management operation indicated in the indication information is to remove the fourth semi-persistent resource group from the mutex group; or the “11” in the function indication field indicates that the management operation indicated in the indication information is to remove the fourth semi-persistent resource group from the mutex group.

It should be noted that in this embodiment of the present disclosure, the steps performed by the terminal may form a new embodiment on their own, and the steps performed by the network device may also form a new embodiment on their own. This is not limited to this embodiment of the present disclosure.

In the solution provided in this embodiment of the present disclosure, the terminal removes the fourth semi-persistent resource group from the mutex group based on the indication information sent by the network device, ensuring that the mutex group can be adjusted by the network device, and improving flexibility of the mutex group. In addition, the resulting mutex group prevents retransmission that occurs due to existence of resource groups that are all activated, improving transmission efficiency.

In some embodiments, the management operation is to ungroup the mutex group. In this embodiment of the present disclosure, the network device configures the mutex group for the terminal, and may further ungroup the configured mutex group.

In this embodiment of the present disclosure, in a case where the network device needs to ungroup the mutex group, the network device sends indication information to the terminal, with a management operation indicated in the indication information is to ungroup the mutex group. After receiving the indication information, the terminal can determine that the network device indicates the terminal to ungroup the mutex group.

In some embodiments, the indication information may also be referred to as destruction information or other information. This is not limited to this embodiment of the present disclosure. The indication information may be a DCI, a RRC, or a MAC CE. This is not limited to this embodiment of the present disclosure.

In this embodiment of the present disclosure, the terminal receives the indication information. Then, since the management operation indicated in the indication information is to ungroup the mutex group, the terminal determines the indicated mutex group based on the indication information, and ungroups the indicated mutex group.

In some embodiments, the indication information includes the identifier of the mutex group.

The identifier of the mutex group indicates the mutex group. Alternatively, the identifier of the mutex group is an ordinal number of the mutex group. For example, in a case where the identifier of the mutex group is 1, it indicates that an indicated mutex group is a mutex group 1, or in a case where the identifier of the mutex group is 2, it indicates that an indicated mutex group is a mutex group 2.

In this embodiment of the present disclosure, the terminal determines the identifier of the mutex group based on the received indication information, and ungroups a mutex group indicated in the identifier of the mutex group.

For example, if the identifier of the mutex group included in the indication information is 1, the terminal ungroups a mutex group 1.

In some embodiments, the indication information includes a function indication field, and the function indication field indicates that the management operation indicated in the indication information is to ungroup a mutex group.

In this embodiment of the present disclosure, the indication information sent by the network device to the terminal includes a function indication field, the function indication field indicates to ungroup the mutex group.

For example, the function indication field includes two bits. To be specific, two bits may indicate four different functions. For example, the “00” in the function indication field indicates that the management operation indicated in the indication information is to ungroup a mutex group; or the “01” in the function indication field indicates that the management operation indicated in the indication information is to ungroup a mutex group; or the “10” in the function indication field indicates that the management operation indicated in the indication information is to ungroup a mutex group; or the “11” in the function indication field indicates that the management operation indicated in the indication information is to ungroup a mutex group.

It should be noted that in this embodiment of the present disclosure, the steps performed by the terminal may form a new embodiment on their own, and the steps performed by the network device may also form a new embodiment on their own. This is not limited to this embodiment of the present disclosure.

In the solution provided in this embodiment of the present disclosure, the terminal ungroups the mutex group based on the indication information sent by the network device, ensuring that the mutex group can be adjusted by the network device, and improving flexibility of the mutex group.

It should be noted that the function indication field included in the indication information in this embodiment of the present disclosure indicates different management operations by using different parameter values.

For example, the function indication field includes two bits, which may indicate four different functions. For example, the “00” in the function indication field indicates that the management operation indicated in the indication information is to configure a mutex group with a first semi-persistent resource group and a second semi-persistent resource group; the “01” in the function indication field indicates that the management operation indicated in the indication information is to add a third semi-persistent resource group to a mutex group; the “10” in the function indication field indicates that the management operation indicated in the indication information is to remove a fourth semi-persistent resource group from a mutex group; and the “11” in the function indication field indicates that the management operation indicated in the indication information is to ungroup a mutex group.

It should be noted that in this embodiment of the present disclosure, descriptions are provided merely by using examples. In another embodiment, the function indication field may alternatively use another value to indicate a function indicated in the indication information. This is not limited to this embodiment of the present disclosure.

In addition, in this embodiment of the present disclosure, in a case where a terminal already activates a second semi-persistent resource group, and when a network device needs to activate a first semi-persistent resource group within a mutex group to which the second semi-persistent resource group belongs, the network device does not need to send a deactivate signaling that is configured for deactivating the second semi-persistent resource group, but directly sends activate signaling that is configured for activating the first semi-persistent resource group, reducing signaling overheads.

The following provides descriptions by using an example in which the present disclosure is applied to an XR service. A network device configures an SPS resource group #1, an SPS resource group #2, and an SPS resource group #3 for an XR service of a terminal, and the SPS resource group #1, the SPS resource group #2, and the SPS resource group #3 belong to a same mutex group. In a case where the terminal already activates the SPS resource group #1, if the network device needs to activate the SPS resource group #2 and then activate the SPS resource group #3, refer to Table 1. Signaling used in an activation procedure in the present disclosure and signaling used in an activation procedure in the related art are as follows, respectively.

The procedure in the present disclosure is as follows: activate the SPS resource group #2 by first activate signaling, and then activate the SPS resource group #3 by second activate signaling. Two pieces of signaling are used in total.

The procedure in the related art is as follows: release the SPS resource group #1 by first release signaling, activate the SPS resource group #2 by first activate signaling, release the SPS resource group #2 by second release signaling, and then activate the SPS resource group #3 by second activate signaling. Four pieces of signaling are used in total.

TABLE 1
Comparison of signaling overheads in SPS
configuration switchover processes

| | | Quantity of |
|---|---|---|
| | Signaling procedure | signaling |
| Related art | \textcircled{1} Release SPS#1; | 4 |
| | \textcircled{2} activate SPS#2; | |
| | \textcircled{3} release SPS#2; and | |
| | \textcircled{4}activate SPS#3 | |
| The present | \textcircled{1} Activate SPS#2; | 2 |
| disclosure | and \textcircled{2} activate | |
| | SPS#3 | |

In addition, a mutex group is set in the present disclosure. As such, a network device no longer needs to send deactivate signaling, preventing retransmission that occurs because a terminal fails to receive deactivate signaling, and improving transmission efficiency.

Moreover, in the present disclosure, it is ensured that there is at most one activated semi-persistent resource group among semi-persistent resource groups within a mutex group at a same moment. In other words, there is no such a case that a plurality of semi-persistent resource groups are all activated. In this way, utilization of resources is improved.

It should be noted that the above embodiment may be split into new embodiments, or may be combined with another embodiment to form a new embodiment. Combinations between embodiments are not limited to the present disclosure.

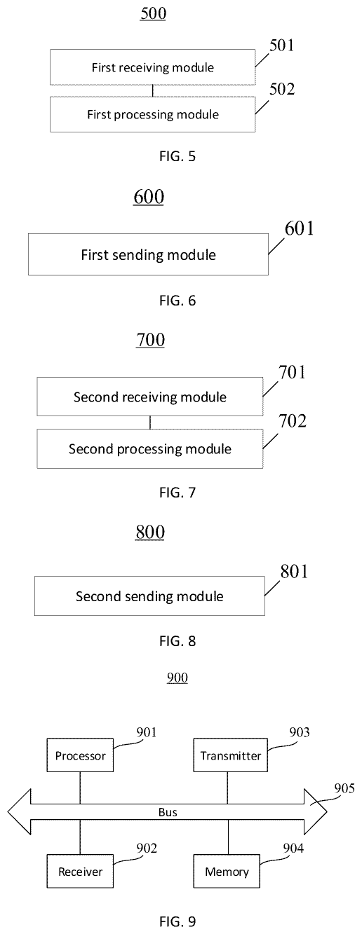

FIG. 5 is a block diagram of a device 500 for activating a resource according to an example embodiment of the present disclosure. With reference to FIG. 5, the device 500 for activating the resource includes a first receiving module 501 and a first processing module 502.
the first receiving module 501, configured to receive an activate signaling sent by a network device, where the activate signaling is configured to indicate to activate a first semi-persistent resource group; and
the first processing module 502, configured to deactivate a second semi-persistent resource group, where
the first processing module 502 is further configured to activate the first semi-persistent resource group,
where a mutex group includes the first semi-persistent resource group and an activated second semi-persistent resource group, and at most one semi-persistent resource group is activated in the mutex group at a same moment.

In some embodiments, the first receiving module 501 is further configured to receive an indication information sent by the network device. The indication information is configured to indicate to perform a management operation on the mutex group.

In some embodiments, the management operation is to configure the mutex group with the first semi-persistent resource group and the second semi-persistent resource group.

In some embodiments, the management operation is to add a third semi-persistent resource group to the mutex group.

In some embodiments, the management operation is to remove a fourth semi-persistent resource group from the mutex group.

In some embodiments, the indication information includes an identifier of the mutex group and an identifier of a semi-persistent resource group, and the semi-persistent resource group includes at least one of the first semi-persistent resource group, the second semi-persistent resource group, a third semi-persistent resource group, or a fourth semi-persistent resource group.

In some embodiments, the management operation is to ungroup the mutex group.

In some embodiments, the indication information further includes an identifier of the mutex group.

In some embodiments, the indication information includes a function indication field, and the function indication field is configured to indicate the management operation indicated in the indication information.

In some embodiments, the semi-persistent resource group is a semi-persistent scheduling SPS resource group or a configured grant CG resource group.

It should be noted that when the device provided in the above embodiment implements its functions, merely division into the functional modules is used as an example for description. During actual application, as needed, the functions may be allocated to different functional modules for implementation. To be specific, an internal structure of a device is divided into different functional modules to implement all or some of the functions described above. In addition, the device provided in the above embodiment pertains to a same concept as the method embodiment. For a specific implementation process of the device, refer to the method embodiment. Details are not described herein again.

FIG. 6 is a block diagram of another device 600 for activating a resource according to an example embodiment of the present disclosure. With reference to FIG. 6, the device 600 for activating the resource includes a first sending module 601.
the first sending module 601, configured to send an activate signaling to a terminal, where the activate signaling is configured to indicate to activate a first semi-persistent resource group,
where a mutex group includes the first semi-persistent resource group and an activated second semi-persistent resource group, and at most one semi-persistent resource group is activated in the mutex group at a same moment.

In some embodiments, the first sending module 601 is further configured to send an indication information to the terminal. The indication information is configured to indicate to perform a management operation on the mutex group.

In some embodiments, the management operation is to configure the mutex group with the first semi-persistent resource group and the second semi-persistent resource group.

In some embodiments, the management operation is to add a third semi-persistent resource group to the mutex group.

In some embodiments, the management operation is to remove a fourth semi-persistent resource group from the mutex group.

In some embodiments, the indication information includes an identifier of the mutex group and an identifier of a semi-persistent resource group, and the semi-persistent resource group includes at least one of the first semi-persistent resource group, the second semi-persistent resource group, a third semi-persistent resource group, or a fourth semi-persistent resource group.

In some embodiments, the management operation is to ungroup the mutex group.

In some embodiments, the indication information further includes an identifier of the mutex group.

In some embodiments, the indication information includes a function indication field, and the function indication field is configured to indicate the management operation indicated in the indication information.

In some embodiments, the semi-persistent resource group is a semi-persistent scheduling SPS resource group or a configured grant CG resource group.

It should be noted that when the device provided in the above embodiment implements its functions, division into the functional modules is used as an example of description. During actual application, as needed, the functions may be allocated to different functional modules for implementation. To be specific, an internal structure of a device is divided into different functional modules to implement all or some of the functions described above. In addition, the device provided in the above embodiment pertains to a same concept as the method embodiment. For a specific implementation process of the device, refer to the method embodiment. Details are not described herein again.

FIG. 7 is a block diagram of another device 700 for activating a resource according to an example embodiment of the present disclosure. With reference to FIG. 7, the device 700 for activating the resource includes a second receiving module 701 and a second processing module 702.
the second receiving module 701, configured to receive an activate signaling sent by a network device, where the activate signaling is configured to indicate to activate a first semi-persistent resource group; and
the second processing module 702, configured to activate the first semi-persistent resource group, where
a mutex group includes the first semi-persistent resource group but does not include an activated second semi-persistent resource group, and at most one semi-persistent resource group is activated in the mutex group at a same moment.

It should be noted that when the device provided in the above embodiment implements its functions, division into the functional modules is used as an example of description. During actual application, as needed, the functions may be allocated to different functional modules for implementation. To be specific, an internal structure of a device is divided into different functional modules to implement all or some of the functions described above. In addition, the device provided in the above embodiment pertains to a same concept as the method embodiment. For a specific implementation process of the device, refer to the method embodiment. Details are not described herein again.

FIG. 8 is a block diagram of another device 800 for activating a resource according to an example embodiment of the present disclosure. With reference to FIG. 8, the device 800 for activating the resource includes a second sending module 801.
the second sending module 801, configured to send an activate signaling to a terminal, where the activate signaling is configured to indicate to activate a first semi-persistent resource group,
where a mutex group includes the first semi-persistent resource group but does not include an activated second semi-persistent resource group, and at most one semi-persistent resource group is activated in the mutex group at a same moment.

It should be noted that when the device provided in the above embodiment implements its functions, division into the functional modules is used as an example of description. During actual application, as needed, the functions may be allocated to different functional modules for implementation. To be specific, an internal structure of a device is divided into different functional modules to implement all or some of the functions described above. In addition, the device provided in the above embodiment pertains to a same concept as the method embodiment. For a specific implementation process of the device, refer to the method embodiment. Details are not described herein again.

FIG. 9 is a diagram of a structure of a communication device 900 according to an example embodiment of the present disclosure. The communication device 900 includes a processor 901, a receiver 902, a transmitter 903, a memory 904, and a bus 905.

The processor 901 includes one or more processing cores. By running a software program and a module, the processor 901 performs a variety of functional applications and information processing.

The receiver 902 and the transmitter 903 may be implemented as a communication component. The communication component may be a communication chip.

The memory 904 is connected to the processor 901 by the bus 905.

The memory 904 may be configured to store at least one piece of program code. The processor 901 is configured to execute the at least one piece of program code to perform the steps in the above method embodiments.

In addition, the communication device may be a terminal or a network device. The memory 904 may be implemented by a volatile storage device of any type, a nonvolatile storage device of any type, or a combination of a volatile storage device and a nonvolatile storage device. The volatile or nonvolatile storage device includes but is not limited to: a magnetic disk or compact disc, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In an example embodiment, a non-transitory computer-readable storage medium is further provided. The readable storage medium stores executable program code. The executable program code is loaded and executed by a processor to implement the resource activation methods that are performed by a communication device and that are provided in the above method embodiments.

In an example embodiment, a chip is provided. The chip includes a programmable logic circuit and/or program instructions. When being run on a terminal or a network device, the chip is configured to implement the resource activation methods provided in the above method embodiments.

In an example embodiment, a computer program product is provided. When being executed by a processor in a terminal or network device, the computer program product is configured to implement the resource activation methods provided in the above method embodiments.

In an example embodiment, an electronic device is provided. the electronic device includes: a processor; a memory that stores executable instructions; and a transceiver connected to the processor, where the executable instructions when executed by the processor cause the electronic device to act as the terminal or network device, and perform the respective method for activating the resource according to the above method embodiments. In an example embodiment, the electronic device may be the terminal, the network device, or the communication device in the above embodiments.

A person of ordinary skill in art may understand that all or some of the steps in the above embodiments may be implemented by hardware or a program instructing related hardware. The program may be stored in a non-transitory computer-readable storage medium. The storage medium mentioned above may be a read-only memory, a magnetic disk, a compact disc, or the like.

The above descriptions are merely optional embodiments of the present disclosure and are not intended to limit the present disclosure. Any modification, equivalent replacement, improvement, and the like made within the spirit and principles of the present disclosure shall fall within the protection scope of the present disclosure.

1. A method for activating a resource, performed by a terminal, the method comprising:
receiving an activate signaling sent by a network device, wherein the activate signaling is configured to indicate to activate a first semi-persistent resource group;
deactivating a second semi-persistent resource group; and
activating the first semi-persistent resource group,
wherein a mutex group comprises the first semi-persistent resource group and an activated second semi-persistent resource group, and at most one second semi-persistent resource group is activated in the mutex group at a same moment.

2. The method according to claim 1, wherein the method further comprises:
receiving an indication information sent by the network device, wherein the indication information is configured to indicate to perform a management operation on the mutex group.

3. The method according to claim 2, wherein the management operation comprises configuring the mutex group with the first semi-persistent resource group and the second semi-persistent resource group.

4. The method according to claim 2, wherein the management operation comprises at least one of: adding a third semi-persistent resource group to the mutex group or removing a fourth semi-persistent resource group from the mutex group.

5. (canceled)

6. The method according to claim 2, wherein the indication information comprises an identifier of the mutex group and an identifier of a semi-persistent resource group, and the semi-persistent resource group comprises at least one of the first semi-persistent resource group, the second semi-persistent resource group, a third semi-persistent resource group, or a fourth semi-persistent resource group.

7. The method according to claim 2, wherein the management operation comprises ungrouping the mutex group.

8. The method according to claim 7, wherein the indication information further comprises an identifier of the mutex group.

9. The method according to claim 2, wherein the indication information comprises a function indication field, and the function indication field is configured to indicate the management operation indicated in the indication information.

10. The method according to claim 6, wherein the semi-persistent resource group is a semi-persistent scheduling (SPS) resource group or a configured grant (CG) resource group.

11. A method for activating a resource, performed by a network device, the method comprising:
sending an activate signaling to a terminal, wherein the activate signaling is configured to indicate to activate a first semi-persistent resource group,
wherein a mutex group comprises the first semi-persistent resource group and an activated second semi-persistent resource group, and at most one semi-persistent resource group is activated in the mutex group at a same moment.

12. The method according to claim 11, wherein the method further comprises:
sending an indication information to the terminal, wherein the indication information is configured to indicate to perform a management operation on the mutex group.

13. The method according to claim 12, wherein the management operation comprises configuring the mutex group with the first semi-persistent resource group and the second semi-persistent resource group.

14. The method according to claim 12, wherein the management operation comprises at least one of: adding a third semi-persistent resource group to the mutex group, or removing a fourth semi-persistent resource group from the mutex group.

15. (canceled)

16. The method according to claim 12, wherein the indication information comprises an identifier of the mutex group and an identifier of a semi-persistent resource group, and the semi-persistent resource group comprises at least one of the first semi-persistent resource group, the second semi-persistent resource group, a third semi-persistent resource group, or a fourth semi-persistent resource group.

17. The method according to claim 12, wherein the management operation comprises ungrouping the mutex group.

18. The method according to claim 17, wherein the indication information further comprises an identifier of the mutex group.

19. The method according to claim 12, wherein the indication information comprises a function indication field, and the function indication field is configured to indicate the management operation indicated in the indication information.

20. (canceled)

21. A method for activating a resource, performed by a terminal, the method comprising:
receiving an activate signaling sent by a network device, wherein the activate signaling is configured to indicate to activate a first semi-persistent resource group; and
activating the first semi-persistent resource group,
wherein a mutex group comprises the first semi-persistent resource group but does not comprise an activated second semi-persistent resource group, and at most one semi-persistent resource group is activated in the mutex group at a same moment.

22-26. (canceled)

27. An electronic device, wherein the electronic device comprises:
a processor;
a memory that stores executable instructions; —and
a transceiver connected to the processor, wherein
the executable instructions when executed by the processor cause the electronic device to act as the terminal and perform the method for activating the resource according to claim 1.

28. (canceled)

29. A non-transitory computer-readable storage medium storing an executable program code, wherein the executable program code, when loaded and executed by a processor of the terminal, cause the terminal to perform the method for activating the resource according to claim 1.
